(19) United States
(12) Patent Application Publication
(10) Pub. No.: US 2026/0295921 A1
(43) Pub. Date: Oct. 1, 2026

(54) Method for deforming a hollow body made of thermoplastic plastic and system therefor

(71) Applicant: BEGA Gantenbrink-Leuchten KG, Menden (DE)

(72) Inventor: Heinrich Johannes GANTENBRINK, Menden (DE)

(73) Assignee: BEGA Gantenbrink-Leuchten KG, Menden (DE)

(21) Appl. No.: 19/632,738

(22) Filed: Mar. 30, 2026

(30) Foreign Application Priority Data
Mar. 31, 2025 (LU) LU600961

(51) Int. Cl. B29C 49/64; B29C 49/48; B29K 33/00; B29L 23/00

(52) U.S. Cl. CPC B29C 49/6418; B29C 49/48; B29K 2033/12; B29L 2023/00

(57) ABSTRACT

A method for deforming a hollow body (4) open at both ends made of thermoplastic material includes the following steps: a) the hollow body (4) is placed into a split, closeable mold (1) which specifies the external geometry of the component to be formed; b) the ends of the hollow body (4) are connected to a closed process system; c) the hollow body (4) is brought, in a first heating step, to a temperature below a plasticizing temperature of the plastic; d) the hollow body (4) is heated, in a second heating step, to a temperature above the plasticizing temperature of the plastic; e) after plasticizing has taken place, the internal pressure in the hollow body (4) is increased so that it bears against the inner contour of the mold (1) and is deformed.

### CROSS-REFERENCE TO RELATED APPLICATION

This application claims the benefit of Luxembourg Patent Application LU600961, filed on Mar. 31, 2025, the entire contents of which is incorporated by reference.

### TECHNICAL FIELD

The disclosure relates to a method for deforming a hollow body, open at both ends, made of thermoplastic material, and to a system for deforming a hollow body, open at both ends, made of thermoplastic material.

### BACKGROUND

For shaping thermoplastic hollow bodies, various methods are available in industrial practice, which differ with regard to process control, energy requirement, geometry flexibility and component quality. Particularly established are extrusion blow molding, injection blow molding and stretch blow molding, in which the hollow body is introduced into a split mold by compressed air or mechanical stretching and is adapted there to the contour. In addition, thermoforming processes are also used, in which prefabricated sheets or half-shells made of thermoplastic material are heated and subsequently deformed by vacuum, compressed air or mechanical contact. These methods are widespread and are used in particular for producing hollow bodies such as bottles, technical containers, transparent covers, lampshades or large-area light domes. The plastic used is in this case generally fully plasticized or at least heated into the thermoplastic range, so that a permanent forming into the desired final contour is possible. The selection of the suitable method depends on the component geometry, the requirements for surface quality and wall thickness distribution, as well as on the material used.

For example, U.S. Pat. No. 7,892,477 discloses a multi-stage blow-molding method with pre-and final blow phase, wherein increased energy efficiency is achieved by controlled pressure profiles as well as recovery of the blow air. DE 199 34 320 A1 furthermore describes the use of preheated blow air for improved temperature control during forming.

For producing optically demanding parts such as luminaire covers, PMMA semi-finished products are frequently processed in the thermoforming process. In this case, uniform heating as well as gentle, low-stress forming are decisive for the optical quality of the end product. Processing instructions, for example from PLEXIGLAS® manufacturers, emphasize the importance of diffuse air routing, precisely tempered tools, as well as coordinated pressure profiles, in order to avoid streaks, wall thickness variations or stress cracks.

Typically, forming takes place by blowing into a split mold using compressed air. Methods of this type are described, for example, in CN 110281507 A or in applications of single-stage injection blow molding machines, in which the hollow body is expanded in a mold that closes around it by air pressure. The air supply takes place via suitable nozzles or mandrel systems. However, these known methods are often energy-intensive, since the entire hollow-body material must be brought fully to processing temperature. Furthermore, with the usual process control with single pressurization, more complex geometries or a uniform wall thickness distribution can be realized only to a limited extent.

### SUMMARY

An object of the disclosure is to provide a method as well as a device for deforming thermoplastic hollow bodies, which enables a precisely controllable and energy-efficient forming and is in particular suitable for the production of lighting covers.

The object is achieved by the method and system as disclosed herein.

A method is provided for the shape-forming processing of a hollow body open at both ends made of thermoplastic material, which is particularly suitable for producing transparent or translucent luminaire covers. For this purpose, the hollow body is first placed into a split, closeable mold, the inner contour of which defines the desired external geometry of the finished component. By closing the mold, the hollow body is fixed in a form-fitting manner, wherein the mold halves form a shaping cavity. The two open ends of the hollow body are then connected to a closed process system which serves for the targeted thermal and pressure-related influencing of the interior space. In a first heating step, the hollow body is first brought to a temperature below the plasticizing temperature of the thermoplastic material used. This step serves for uniform preheating of the material without already deforming it plastically. The system pressure remains in particular low. In a subsequent second heating step, the temperature is increased further so that the plastic reaches a temperature above its plasticizing temperature and transitions into a plastically deformable state. After complete plasticizing, a targeted pressure increase takes place in the interior of the hollow body, as a result of which it bears against the inner contour of the mold under the effect of the internal pressure. The hollow body in this case assumes the desired component geometry. After the forming process has taken place, the component can be solidified by cooling and removed from the mold.

By the combination of two-stage, thermally gentle heating and controlled pressure build-up within a closed process system, a particularly uniform wall thickness distribution is achieved. The method is therefore particularly suitable for optically demanding applications such as the production of luminaire covers made of PMMA or other plastics suitable for lighting technology, in which, in addition to dimensional accuracy, high transparency and surface quality are required. In addition, the modular coupling of the hollow body to the process system permits high flexibility with regard to the geometries to be processed.

In a preferred embodiment of the method, for carrying out the two heating steps, a flowable medium is used as heat transfer medium, which is conducted through the interior space of the hollow body. The flowing medium ensures uniform heat distribution along the inner wall of the hollow body and enables effective and controllable temperature control. Particularly suitable in this case is the use of air as heat transfer medium, since it is easy to temper, well controllable and easy to handle in terms of process technology. The air can in this case be specifically preheated, accelerated and conducted through the hollow body via suitable lines or circuit systems in order to achieve both the preheating below and the plasticizing above the plasticizing temperature of the plastic. This type of heating is particularly advantageous for lighting-technology applications, since, by indirect, convective heat transfer, thermal stresses are minimized and undesired local overheating can be avoided. The use of a flowable medium as heat transfer medium furthermore permits dynamic control of the temperature profile in the hollow body, whereby the method can be adapted to different geometries and material thicknesses.

In a further preferred embodiment, the flowing medium, in particular the air used for heating, is conducted in a circuit within a closed process system. The closed system ensures that the air heated once does not escape in an uncontrolled manner, but can be specifically circulated and reused. In this way, constant and energy-efficient tempering of the hollow body is made possible. For maintaining air circulation within this closed circuit, the process system is equipped with a blower, which ensures continuous circulation of the medium. The blower ensures that the flowable medium is conducted uniformly through the hollow body and thus a homogeneous heat distribution is achieved in all regions of the interior space.

In an advantageous further development of the method, the first heating step, in which the hollow body is preheated to a temperature below the plasticizing temperature of the plastic, is supported by a thermal storage element. The thermal storage element can be designed either passively or actively and serves to supply heat to the flowable medium, in particular the air, in an energetically efficient manner. As a result, the temperature level in the process system is stabilized and uniform preheating of the hollow body is ensured. The thermal storage element can be designed, for example, as a solid body through which air flows, which was previously heated and releases its stored heat to the medium conducted through it. Alternatively, the element can be actively heated in order to enable targeted temperature control during the preheating phase. The use of such a heat store enables a constant, defined energy supply in the early process phase, whereby the thermal transition of the plastic into the plasticizable range is prepared in a controlled manner. This contributes to the reduction of temperature gradients and thus to the avoidance of internal stresses in the material—an essential advantage in the production of optically demanding components such as luminaire covers.

According to a further preferred embodiment of the method, the second heating step, in which the hollow body is heated to a temperature above the plasticizing temperature of the plastic, takes place using a heating register. The heating register serves as an active heat unit for targeted raising of the temperature of the flowable medium, in particular the air circulating in the closed process system. In contrast to the comparatively gentle and energetically buffered preheating by means of heat storage, the heating register enables a precisely controllable and rapid temperature increase in order to transfer the thermoplastic material into a plastically deformable state. The temperature of the heating register can in this case be adapted depending on material, geometry and process time in order to achieve the most low-stress plasticizing possible with uniform heat distribution. The use of a heating register permits, in particular, flexible process control in which the intensity and duration of plasticizing can be specifically regulated.

It is preferred that the temperature control during the first and/or second heating step takes place as a function of temperature and/or time. In this way, the thermal course in the hollow body can be matched particularly precisely to the material properties of the thermoplastic material used as well as to the geometric conditions of the workpiece. In temperature-dependent control, the respective current medium temperature is continuously monitored and controlled, so that defined temperature levels can be specifically approached and maintained. This enables reproducible preheating and plasticizing with high process reliability. Alternatively or additionally, the control can take place as a function of time by specifying the heating duration exactly, which permits efficient and cycle-stable process control particularly in the case of known material parameters and standardized geometries. The temperature- and/or time-dependent control of the heating steps contributes to avoiding local overheating or insufficient plasticizing.

In a further preferred embodiment of the method, the internal pressure in the hollow body is set via an adjustable pressure regulator. The pressure regulator is in this case part of the closed process system and enables targeted control of the pressure level in the interior space of the hollow body during forming. The setting of the internal pressure takes place preferably as a function of the material temperature achieved and the desired forming sequence. By the possibility of finely tuned pressure increase after the second heating step, the thermoplastically deformable hollow body can be applied in a controlled manner against the inner contour of the closed mold, whereby uniform wall thickness distribution and high forming accuracy are achieved. In addition, by suitable pressure control, possible material distortions or fold formations during expansion of the hollow body can be avoided.

In a preferred embodiment, polymethyl methacrylate (PMMA) is used as thermoplastic material. PMMA is distinguished by high light transmission, good optical clarity as well as comparatively low thermal expansion and is therefore particularly suitable for producing transparent or translucent luminaire covers. Due to its thermoplastic properties, PMMA can be plasticized under controlled heating and subsequently adapted with dimensional accuracy to a mold contour by internal pressure without losing optical quality. Alternatively, other suitable thermoplastic materials can also be used which exhibit comparable deformability and optical suitability. These include, in particular, polycarbonate (PC), which is distinguished by high impact strength and temperature resistance, as well as styrene-acrylonitrile (SAN) or cyclo-olefin copolymers (COC), which are used for applications with high requirements for transparency and dimensional accuracy. Also translucent or colored variants of these materials can be processed within the scope of the method, provided that they have a definable plasticizing temperature and can be deformed in a shape-forming manner under controlled conditions. By the material selection, the method can be specifically adapted to different lighting-technology requirements, for example with regard to light transmittance, scattering, UV resistance or mechanical strength.

The disclosure furthermore relates to a system for deforming a hollow body open at both ends made of thermoplastic material and is in particular suitable for carrying out the method described above. It comprises a split, closeable mold which is designed for form-fitting reception of the hollow body. The inner contour of the mold corresponds in this case to the desired external geometry of the component to be produced, so that the hollow body completely assumes the target contour after forming has taken place. For process-side connection of the hollow body, the system is provided with a connection device which connects both open ends of the hollow body to a closed process system. This process system serves for targeted thermal conditioning and pressurization of the interior space of the hollow body.

For carrying out the two-stage heating of the hollow body, the system comprises a correspondingly designed heating device. This is set up to bring the hollow body, in a first heating step, to a temperature below the plasticizing temperature of the thermoplastic material used in order to uniformly pre-condition the material. In a second heating step, the temperature is then raised to a value above the plasticizing temperature so that the plastic transitions into a deformable state.

A pressure device integrated in the system is provided to generate a controlled internal pressure in the hollow body after plasticizing. This pressure causes the wall of the hollow body to bear uniformly against the inner contour of the mold, whereby the component assumes the predetermined geometry.

In a preferred embodiment of the system, the heating device has a guide for a flowable medium which serves as heat transfer medium. The medium is conducted specifically through the closed process system and in this case acts on the inner wall of the hollow body in order to thermally condition it. Air has proven particularly suitable in this case, since it is inexpensive as heat transfer medium, well regulatable and easily integrable into the circuit. The embodiment of the heating device as a flow-guided system enables uniform and large-area heat transfer along the entire internal volume of the hollow body. The flowing medium can in this case be used both in the first and in the second heating step. The use of a flowable medium furthermore permits flexible adaptation to different geometries and wall thicknesses of the hollow body, since the medium distributes uniformly in the interior space and thus supports a homogeneous temperature distribution.

In a further preferred embodiment of the system, it is provided that the flowable medium, in particular the heated air, is conducted in a closed circuit which also includes the hollow body. The closed circuit is designed such that, after flowing through the hollow body, the medium is returned to the process system and can there be heated or conditioned again.

The closed circuit guidance furthermore offers the advantage that the medium can be specifically filtered, dried or freed from contaminants before it is conducted again through the hollow body. This is of particular importance when high optical quality of the finished workpiece is required, such as, for example, in transparent luminaire covers.

The closed circuit can be realized, for example, by a system of temperature-resistant pipe or hose lines which guides the flowable medium successively through a thermal storage element, a heating register, the hollow body and a circulation device, in particular a blower. In this case, the medium can circulate completely within the system without coming into contact with the ambient air. Alternatively, the circuit can also be integrated into a process chamber within which the medium is guided via deflection devices and defined flow paths. The return flow of the medium takes place preferably directly to the thermal storage element or blower, so that continuous circulation is made possible.

In a further preferred embodiment, the heating device comprises a thermal storage element which is provided for carrying out the first heating step. The thermal storage element serves to supply thermal energy to the flowable medium—in particular air—in order to first heat the hollow body to a temperature below the plasticizing temperature of the plastic. The thermal storage element can in this case be designed as a passive or actively heated body which is arranged in the closed circuit of the medium. Preferably, it is a heat-conducting solid body which is brought beforehand to a defined temperature level and transfers heat when the medium flows through. Such an embodiment enables energy-efficient preheating of the hollow body with simultaneously high temperature stability in the first heating step. By the use of a thermal storage element, the temperature profile of the medium in the process system can be specifically influenced, whereby uniform, material-gentle preheating is achieved.

In an advantageous alternative, the thermal storage element is designed as a tube-bundle storage device. Such a tube-bundle storage device comprises a plurality of parallel-running, heat-conducting tubes which are surrounded by a shell. The flowable medium, in particular air, is conducted through the tube space or the shell space while the heat storage material—for example an electrically or externally heatable metal block system—stores thermal energy and releases it to the medium flowing through. The tube-bundle construction permits a large heat transfer area in a confined space and ensures homogeneous tempering of the medium over the entire cross-sectional area. Depending on the embodiment, the storage device can be operated passively by preheating or actively by integrated heating elements. The system can in this case be designed such that the medium is guided through the tube bundle with controlled flow velocity in order to ensure the desired temperature for the first heating step. Technically, the tube-bundle storage device can be integrated into the closed circuit, wherein it is positioned between the blower and the hollow body. Optionally, temperature sensors can be provided at the inlet and outlet in order to optimize the regulation of the stored heat.

Furthermore, it is advantageously provided that the heating device is configured as a heating register which is provided for carrying out the second heating step. The heating register is set up to heat the flowable medium—in particular air—specifically to a temperature above the plasticizing temperature of the thermoplastic material used in order to make the hollow body fully plasticizable. Technically, the heating register can be designed, for example, as an electrically heated pipe section, as a continuous-flow heater with integrated heating elements, or as a fin or lamella register with a large-area heat transfer region. It is positioned in the flow course of the closed process system such that, after passing through the heat storage element in the first heating step, the medium enters directly into the heating register and is there brought to the required final temperature level. By the targeted positioning and regulation of the heating register, the temperature control in the second heating step can be controlled exactly.

In a preferred further development, the connection device has form-fitting connecting means which are provided for the process-reliable connection of the two open ends of the hollow body to the closed process system. These connecting means serve in particular for centered positioning and sealed coupling of the hollow body to the system for carrying out the heating and forming steps. Preferably, the connecting means are designed as conical fitting pieces which, when inserted into the hollow-body ends, position themselves in a self-centering manner and bear in a form-fitting manner by their cone. For sealing, an elastic sealing element—for example an O-ring—can additionally be provided between the fitting piece and the inner wall of the hollow body. Alternatively, other embodiments can also be used, for example clamping jaws, clamping rings, bayonet closures, flange systems or plug-in connections with sealing elements, depending on the geometry of the hollow body and the requirements for pressure tightness and reproducibility.

By the use of form-fitting connecting means, a reliable connection with minimal assembly effort is made possible, which is particularly advantageous in the case of changing component geometries or automated processes. The central alignment of the fitting pieces furthermore contributes to uniform flow distribution and pressure control in the hollow body, which has a positive effect on the forming accuracy of the component.

Further advantageous embodiments are explained in more detail with reference to exemplary embodiments shown in the drawing.

### BRIEF DESCRIPTION OF THE DRAWINGS

FIG. 1 shows a perspective illustration of a split mold,

FIG. 2 shows an opened mold half with hollow body and

FIG. 3 shows a schematic illustration of the system for deforming a thermoplastic hollow body.

### DETAILED DESCRIPTION

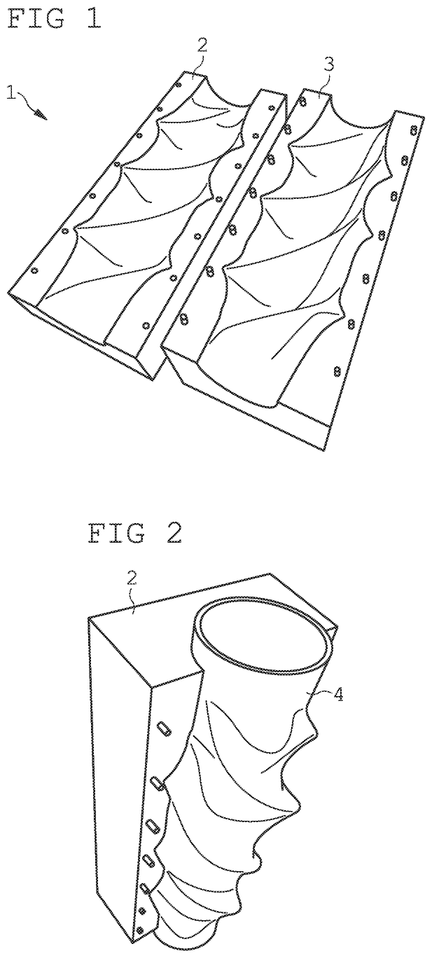

FIG. 1 shows a perspective illustration of a split mold 1, consisting of two associated mold halves 2, 3. The mold halves 2, 3 are each shaped such that together they form a shaping inner contour for producing a component-specific formed part. The mold 1 can be opened and closed, wherein the two halves 2, 3 are aligned exactly with one another via suitable guide elements and a clamping device (not shown). In the closed state, the inner surfaces of the halves form a cavity-like shape which corresponds to the later luminaire cover.

FIG. 2 shows one of the two mold halves 2, 3 in the opened state. In the inner contour of the mold half 2, 3, a thermoplastic hollow body 4 is placed, which in the illustrated example is designed as a preformed luminaire cover. The hollow body 4 bears against the shaping contour of the mold half 2, 3, wherein the second mold half 2, 3 (not shown) is added for complete enclosure of the hollow body 4. The open ends of the hollow body 4 are not shown in this view but can be connected to the process system via suitable connection devices. The illustration clarifies the geometric adaptation of the hollow body 4 to the mold 1 and its positioning.

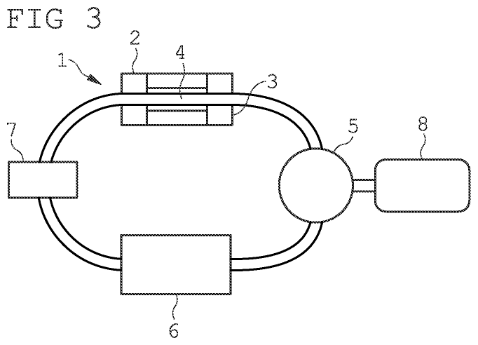

FIG. 3 shows a schematic illustration of the system for deforming a thermoplastic hollow body. The illustration comprises functional units which are advantageous for carrying out the method. Of course, the system can be supplemented by further units. At the center is a split, closeable mold 1 which consists of two mold halves 2, 3 and into which a hollow body 4 open at both ends is placed. The inner contour of the mold 1 corresponds to the later component geometry, for example a luminaire cover.

The hollow body 4 is connected via a connection device not shown to a closed process system which serves for circulating, heating and pressurizing a flowable medium. The process system is schematically indicated by a line and comprises a blower 5 which is provided for circulating the medium, e.g. air, within a closed circuit. Downstream in the direction of flow is a heat storage device 6 which supports the first heating step below the plasticizing temperature of the plastic. Subsequently, a heating register 7 is arranged which realizes the second heating step at a temperature above the plasticizing temperature.

For pressure control, a pressure regulator 8 is provided which increases the internal pressure in the hollow body 4 in a targeted manner so that, in the plasticized state, it bears against the inner contour of the mold 1. The interaction of the components mentioned enables precise thermal conditioning and shape-forming deformation of the hollow body 4 within the closed system.

### LIST OF REFERENCE SIGNS

1. Mold
2. First mold half
3. Second mold half
4. Hollow body
5. Blower
6. Heat storage device
7. Heating register
8. Pressure regulator

What is claimed is:

1. A method for deforming a hollow body (4) open at both ends and made of a thermoplastic material, the method comprising:
placing the hollow body (4) into a split, closeable mold (1) that defines an external geometry of a component to be formed;
connecting the ends of the hollow body (4) to a closed process system,
heating the hollow body (4), in a first heating step, to a temperature below a plasticizing temperature of the thermoplastic material;
heating the hollow body (4), in a second heating step, to a temperature above the plasticizing temperature of the thermoplastic material; and
increasing, after plasticizing, an internal pressure in the hollow body (4) such that the hollow body (4) bears against an inner contour of the mold (1) and is deformed.

2. The method of claim 1, wherein the first heating step and the second heating step each use a flowable medium as a heat transfer medium, the flowable medium comprising air.

3. The method of claim 2, wherein the flowable medium is circulated within the closed process system in a circuit comprising a blower (5).

4. The method of claim 1, wherein the first heating step is assisted by a heat storage device (6).

5. The method of claim 1, wherein the second heating step is carried out using a heating register (7).

6. The method of claim 1, wherein temperature control during the first heating step and/or the second heating step is performed as a function of temperature and/or time.

7. The method of claim 1, wherein the internal pressure in the hollow body (4) is set via an adjustable pressure regulator (8).

8. The method of claim 1, wherein the hollow body (4), before being placed into the mold (1), is preheated in an external heat source to a temperature below the plasticizing temperature of the thermoplastic material.

9. The method of claim 1, wherein the thermoplastic material is polymethyl methacrylate (PMMA).

10. A system for deforming a hollow body (4) open at both ends and made of thermoplastic material, the system comprising:
a split, closeable mold (1) configured to receive the hollow body (4), the mold having an inner contour that defines an external geometry of a component to be formed;
a connection device configured to connect both ends of the hollow body (4) to a closed process system;
a heating device configured to heat the hollow body (4), in a first heating step, to a temperature below a plasticizing temperature of the thermoplastic material and, in a second heating step, to a temperature above the plasticizing temperature of the thermoplastic material; and
a pressure device configured to generate an internal pressure in the hollow body (4) such that the hollow body bears against the inner contour of the mold (1) and is deformed.

11. The system according to claim 10, wherein the heating device comprises a conduit for a flowable medium serving as a heat transfer medium, the flowable medium comprising air.

12. The system according to claim 11, wherein the flowable medium is circulated in a closed circuit through the hollow body (4).

13. The system according to claim 10, wherein the heating device comprises a thermal storage element (6) configured to carry out the first heating step.

14. The system according to claim 13, wherein the thermal storage element (6) is a tube-bundle storage device.

15. The system according to claim 10, wherein the heating device comprises a heating register (7) configured to carry out the second heating step.

16. The system according to claim 10, wherein the connection device comprises form-fitting connecting means, the connecting means comprising conical fitting pieces.
